(19) United States
(12) Patent Application Publication
(10) Pub. No.: US 2007/0201942 A1
(43) Pub. Date: Aug. 30, 2007

(54) Storage receptacle for school supplies

(75) Inventor: David V. Shapiro, Chicago, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: It's Academic of Illinois, Inc.

(21) Appl. No.: 11/357,502

(22) Filed: Feb. 17, 2006

(51) Int. Cl. B42F 13/00

(52) U.S. Cl. 402/79

(57) ABSTRACT

A storage receptacle for small supplies, including a pouch having rectangular front and back faces connected together along three of the sides to define a storage space between the faces. A releasable closure element on the fourth side blocks access to the storage space on the fourth side when closed and allows access into the storage space through the fourth side when opened. A releasable adhesive is on the exterior side of the back face, and a removable backing is over the releasable adhesive. A mounting tab is on at least one of the three connected sides of the faces, which tab includes at least one defined opening from which the pouch may be hung. A second mounting tab may also be provided on another face side.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward storage receptacles, and particularly toward storage receptacles for small supplies such as school and writing supplies such as may be required by a student.

### BACKGROUND OF THE INVENTION AND TECHNICAL PROBLEMS POSED BY THE PRIOR ART

School and writing supplies such as pens, pencils, erasers, rulers and the like are loose items which must be kept by people of all ages, and particularly young children and young adults alike. Particularly in school settings where the students need these items at a variety of places (e.g., different classrooms), keeping track of such different small items can be a daunting task, particularly for younger children.

Pencil bags, as well as small boxes, have long been used by students for such supplies, with such bags and boxes typically being carried separately by the student, and therefore susceptible to being forgotten by the student who has to gather up other items such as notebooks and books at the end of a class.

To assist in carrying such bags, for example, strips have been provided along one side with openings therein allowing the bags to be secured to the binder rings inside notebooks. However, securing a pencil bag inside of a notebook can significantly reduce the amount of papers which may be mounted to the notebook rings. Moreover, odd sized and shaped items such as pencil bags mounted inside notebooks can result in an uneven content which can result in twisting of the notebook covers which, overtime, may result in the notebook covers being distorted or otherwise damaged. As a result, while mounting inside a notebook, for example, can be advantageous in helping to ensure that the bag and its contents not be lost, such a location is not always desirable. In fact, over the course of a school year, as the contents of a student's notebook change, it may be perfectly acceptable at some times to secure a pencil bag inside a notebook and at other times may be highly undesirable. Of course, if different bags or boxes are used depending upon a particularly preferred type of mounting, then the risk of losing or forgetting the appropriate bag is significantly higher.

Moreover, there may be different times during the year, or different practices of students, where it is desired to not carry such supplies to classrooms at all. For example, some students may wish to keep such supplies at a locker and only bring what they will need from those supplies to a particular class, whereas others may prefer to carry all of their supplies with them at all times.

Given such variations in use, it is difficult for parents and others to ensure that they are providing supplies and supply holders which best meet the needs, practices, and routines of their particular student.

The present invention is directed toward overcoming one or more of the problems set forth above.

### SUMMARY OF THE INVENTION

In one aspect of the present invention, a storage receptacle for small supplies is provided, including a pouch having a generally translucent front face and a back face, with the faces being generally rectangular and connected together along three of the sides to define a storage space between the faces. A releasable closure element is provided on the fourth side, where the closure element blocks access to the storage space on the fourth side when closed and allows access into the storage space through the fourth side when opened. A releasable adhesive is on the exterior side of the back face, and a removable backing is over the releasable adhesive. A mounting tab is on one of the three connected sides of the faces, which tab includes at least one defined opening from which the pouch may be hung.

In one form of this aspect of the present invention, the closure element is a snap closable flap along the fourth side.

In another form of this aspect of the present invention, the closure element is a zipper adjacent the fourth side.

In still another form of this aspect of the present invention, the adhesive covers at least 50% of the back face.

In yet another form of this aspect of the present invention, the connection between the three face sides includes folded bridging closure material allowing expansion of the space between the front and back faces.

In another form of this aspect of the present invention, a second mounting tab is provided on a face side other than the one of the three connected sides.

In still another form of this aspect of the present invention, the rectangular faces are not square, and the mounting tab comprises a centrally located projection along one of the shorter sides.

In yet another form of this aspect of the invention, the mounting tab is a reinforced strip along the length of the one of the three connected sides, where the reinforced strip includes defined openings for binder rings. In a further form, the defined openings are lines of weakening facilitating selected removal of material to open the defined openings.

### BRIEF DESCRIPTION OF THE DRAWINGS

FIG. 1 is a perspective view of a storage receptacle according on a first embodiment of the present invention;

FIG. 2 is a perspective view of a storage receptacle according on a second embodiment of the present invention;

FIG. 3 is a perspective view of a storage receptacle according on a third embodiment of the present invention;

FIG. 4 is a perspective view of a storage receptacle according on a fourth embodiment of the present invention;

FIG. 5 is a perspective view of a storage receptacle according on a fifth embodiment of the present invention;

FIG. 6 is a perspective view of a storage receptacle according on a sixth embodiment of the present invention;

FIG. 7 is a partial perspective view of a storage receptacle according on a seventh embodiment of the present invention;

FIG. 8 is a perspective view of the back of a storage receptacle of any of the first, third and fourth embodiments of the present invention;

FIG. 9 is a perspective view of a binder with a storage receptacle according on a seventh embodiment of the present invention mounted thereon; and

FIG. 10 is a perspective view of a locker with a storage receptacle according to the first embodiment of the present invention mounted thereon.

### DETAILED DESCRIPTION OF THE INVENTION

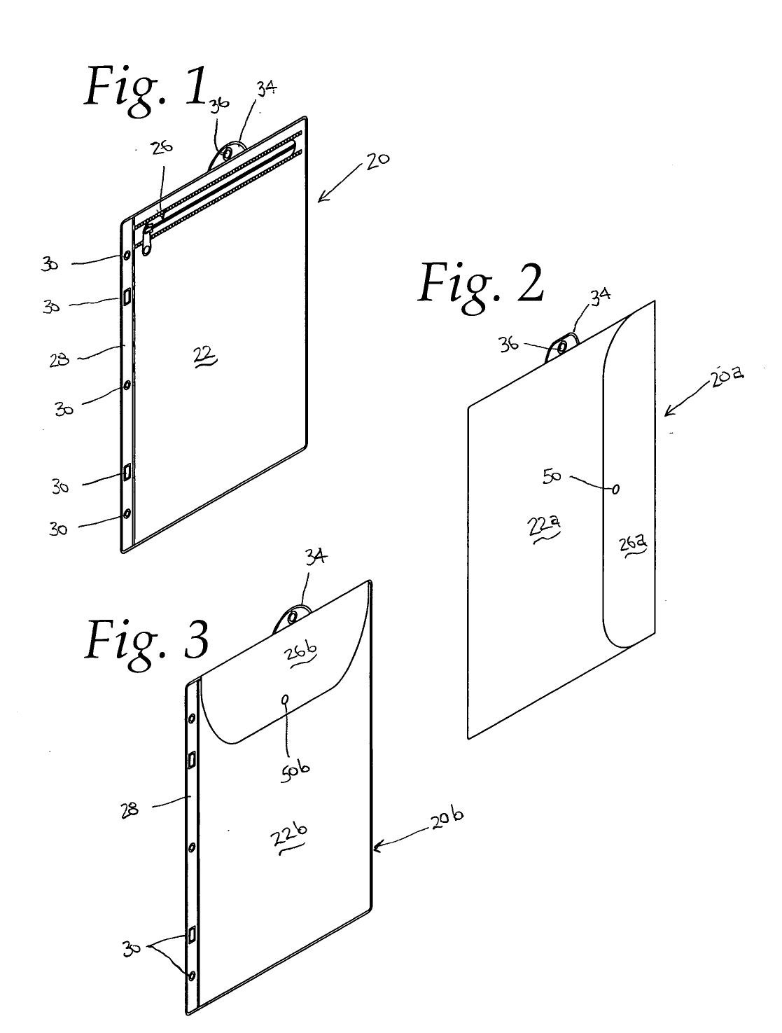

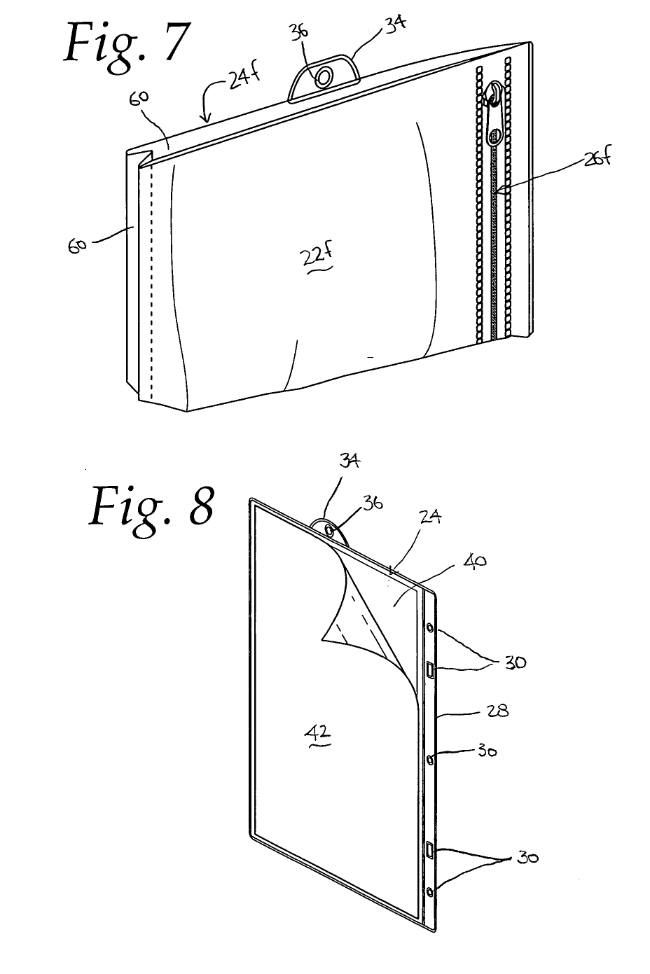

A first embodiment of a storage receptacle 20 according to the present invention is illustrated in FIGS. 1 and 8. The receptacle 20 consists of a rectangular front face 22 (which may advantageously be transparent, or at least translucent, so that the contents of the receptacle 20 may be seen from the outside) secured around at least three edges to a rectangular back face 24 (see FIG. 8). The faces 22, 24 may advantageously be made of suitable durable and flexible plastic materials.

In the embodiment of FIGS. 1 and 8, a closure element consisting of an interlocking profiled zipper 26 is provided in the front face 22 adjacent the fourth side, which zipper 26 may be selectively opened or closed to allow access to, or close off, a storage area between the faces 22, 24. Supplies such as school supplies (or other suitably sized supplies), including pens, pencils, erasers, rulers and the like may be readily stored in the storage area inside the receptacle 20.

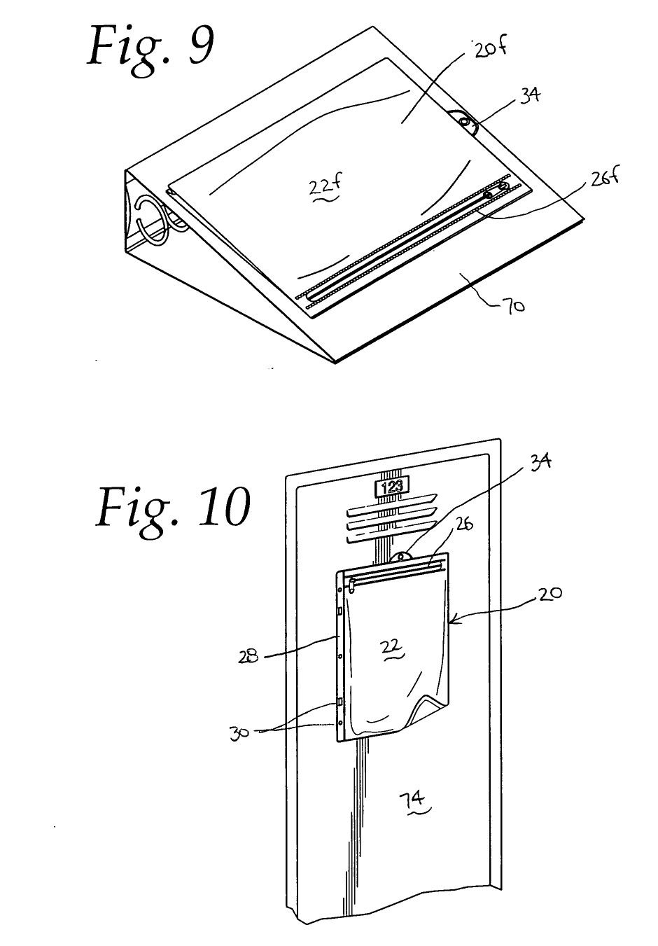

A mounting tab extends along the length of one of the secured sides of the receptacle 20 to form a strip 28 which may be advantageously reinforced, as by securing together the front and back faces 22, 24 along that length to close off the storage area from that strip 28, effectively forming a double thickness strip 28. A plurality of openings 30 may be advantageously defined in the strip 28, suitably spaced, for example, to accommodate the rings of standard two- and three-ring binders (see, e.g., FIG. 9). Moreover, the openings 30 may be fully provided (i.e., with the material punched out from the strip 28), or they may be defined by lines of weakening around the location of the opening 30 so that a user may readily punch out the material at locations where openings will be desired for a given use.

Another mounting tab 34 is mounted on the top at the center of the short side of the receptacle 20 of the FIGS. 1 and 8 embodiment. A suitable opening 36 is provided in the top tab 34, whereby the receptacle may be hung from a hook (not shown) extending through the opening 36 in the top tab 34.

As shown in FIG. 8, a suitable releasable adhesive 40 is advantageously provided over a substantial portion of the back face 24 of the receptacle 20 (suitable adhesive 40 is available, e.g., from 3M Company of St. Paul, Minn., USA). A suitable release sheet 42 is also provided over the adhesive 40 to both protect the adhesive 40 when not intended to be used, and to prevent the receptacle 20 from adhering to a surface when such adhesion is not desired. It should thus be appreciated that the receptacle 20 may not only be secured in a binder, but it may also be secured on the outside of a binder (see FIG. 9) or on a locker (see FIG. 10), or even secured to the rings of a binder and secured to a selected item, such as a divider, in the notebook, or in a wide variety of positions and places, whereby a single receptacle 20 may thereby accommodate the different practices and changing practices of virtually all students. In that case, even without knowing exactly how a child handles their school supplies, a parent or anyone may confidently buy a single receptacle 20 of this design knowing that the receptacle 20 will be suitable for whatever the student does.

A second embodiment is illustrated in FIG. 2, wherein identical elements are given identical reference numbers to the FIG. 1 embodiment, and similar but modified elements are given the same reference numbers with the letter “a” added. The receptacle 20a of FIG. 2 includes a closure element which is a flap 26a secured to the back face (not shown) and which may be folded over the front face 22a and secured thereto by a suitable snap 50. The receptacle 20a of FIG. 2 does not include a strip for mounting in a two- or three-ring binder, but it does include a secondary mounting element consisting of the mounting tab 34 and opening 36 at the top edge. Though not shown, this embodiment (and all embodiments disclosed herein) advantageously include the releasable adhesive on the back face such as previously described.

FIG. 3 illustrates yet another embodiment wherein identical elements are given identical reference numbers to the FIG. 1 embodiment, and similar but modified elements are given the same reference numbers with the letter “b” added. The receptacle 20b of FIG. 3 is substantially similar to the FIG. 1 embodiment, except that the zipper closure element 26 of FIG. 1 has been replaced by a flap 26b and snap 50b extending along the top of the receptacle 20b.

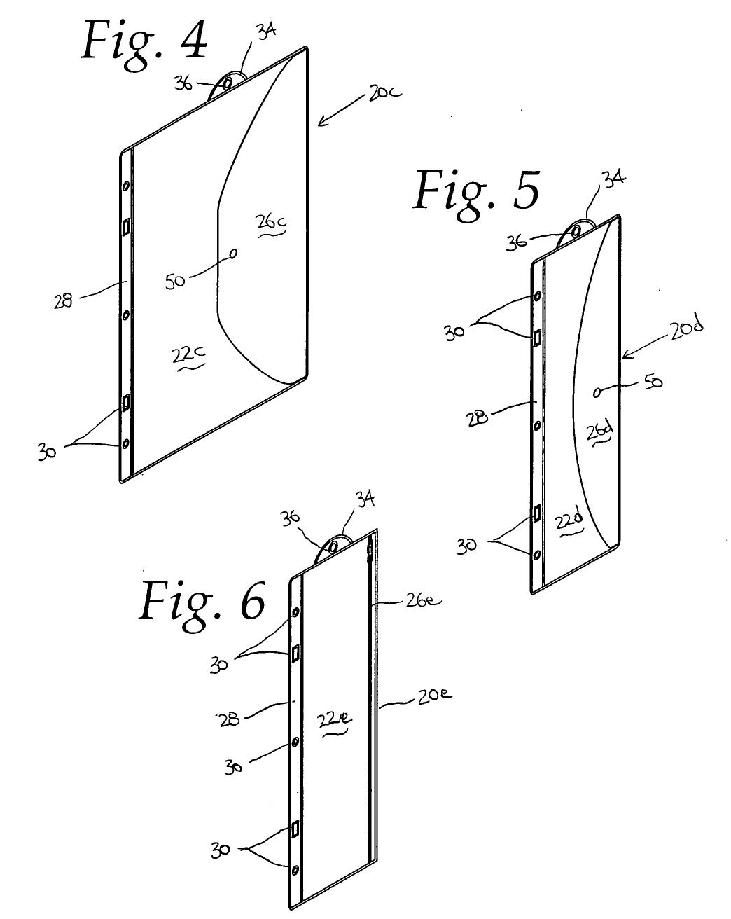

FIG. 4 illustrates another embodiment wherein identical elements are given identical reference numbers to the FIG. 1 embodiment, and similar but modified elements are given the same reference numbers with the letter “c” added. The receptacle 20c of FIG. 4 is substantially similar to the FIG. 1 embodiment, with the reinforced strip 28 and openings 30 along one long side, and a second mounting tab 34 and opening 36 on the top short side. Like the FIG. 2 embodiment, however, the closure element consists of a flap 26c and a suitable snap 50.

FIG. 5 illustrates yet another embodiment wherein identical elements are given identical reference numbers to the FIG. 1 embodiment, and similar but modified elements are given the same reference numbers with the letter “d” added. The receptacle 20d is substantially similar to the embodiment of FIG. 4, except that it is narrower in size (whereas the FIG. 4 embodiment is sized to potentially store papers therein, the FIG. 5 embodiment is more conventionally sized to store elongated supplies such as pens, pencils, rulers, etc.

FIG. 6 illustrates still another embodiment wherein identical elements are given identical reference numbers to the FIG. 1 embodiment, and similar but modified elements are given the same reference numbers with the letter “e” added. This receptacle 20e is substantially similar to the FIG. 5 embodiment, except that the closure element consists of a zipper 26e.

A still further embodiment is illustrated in FIG. 7, wherein identical elements are given identical reference numbers to the FIG. 1 embodiment, and similar but modified elements are given the same reference numbers with the letter “f” added. In this receptacle 20f, the closure element is a standard design zipper 26f. Further, the three edges of the front and back faces 22f, 24f which are connected are connected by bridging closure material 60 allowing expansion of the space between said front and back faces 22f, 24f. A single mounting tab 34 and opening 36 are centrally located on the upper side of the back face 24f.

While FIG. 8 has been previously described as a back view of the FIG. 1 receptacle 20, it should also be appreciated that, FIG. 8 identically illustrates the back face and associated structure of FIGS. 2 and 4. Moreover, as previously noted, it should be appreciated that an adhesive 40 and release paper 42 such as shown in FIG. 8 is similarly incorporated on the back faces 24a, 24d-f in the other embodiments shown in FIGS. 2 and 5-7, respectively.

FIG. 9 illustrates a FIG. 7 receptacle 20f adhered to a three ring binder 70, and FIG. 10 illustrates a FIG. 1 receptacle 20 adhered to a locker door 74. These figures are merely examples of how the various receptacle embodiments may be suitably secured in a desired place by a student, however, and it should be appreciated that any of the seven described embodiments could as well be adhered to either the binder 70 or a locker door 74 according to the desires of the student, as well as virtually any surface (e.g., the inside of a locker door, or a divider within the binder). Of course, as previously described, these receptacles could also be secured in another manner in other desired places, including to the rings inside a binder (for embodiments such as FIGS. 1 and 3-6 having a reinforced strip 28 and openings 30 along one side), or hung from a hook or other support (for all of the disclosed embodiments which include a mounting tab 34 at the center of the top edge.

Accordingly, as previously discussed, any one of these embodiments may be purchased by someone with confidence that the receptacle 20-20f may be mounted in a variety of ways, one of which is likely to meet the wishes and practices of the student who will use them. Moreover, by using releasable adhesive 40, a single receptacle may be mounted in different, changing, ways, according to the changing practices and desires of a student, in addition to the mounting by one or more openings 30, 34 provided, depending upon the embodiment chosen.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A storage receptacle for small supplies, comprising:
a pouch having a generally translucent front face and a back face, said faces being generally rectangular with four sides and connected together along three of said sides to define a storage space between said front and back faces;
a releasable closure element on the fourth side, said closure element blocking access to said storage space on said fourth side when closed and allowing access into said storage space through said fourth side when opened;
a releasable adhesive on the exterior side of said back face;
a removable backing over said releasable adhesive; and
a mounting tab on one of said three connected sides of said faces, said mounting tab including at least one defined opening from which said pouch may be hung.

2. The storage receptacle of claim 1, wherein said closure element comprises a snap closable flap along said fourth side.

3. The storage receptacle of claim 1, wherein said closure element comprises a zipper adjacent said fourth side.

4. The storage receptacle of claim 1, wherein said adhesive covers at least 50% of said back face.

5. The storage receptacle of claim 1, wherein the connection between the three face sides includes folded bridging closure material allowing expansion of the space between said front and back faces.

6. The storage receptacle of claim 1, further comprising a second mounting tab on a face side other than said one of said three connected sides.

7. The storage receptacle of claim 1, wherein said rectangular faces are not square, and said mounting tab comprises a centrally located projection along one of the shorter sides.

8. The storage receptacle of claim 1, wherein said mounting tab comprises a reinforced strip along the length of said one of said three connected sides, said reinforced strip including defined openings for binder rings.

9. The storage receptacle of claim 8, wherein said defined openings comprise lines of weakening facilitating selected removal of material to open said defined openings.
